(19) United States
(12) Patent Application Publication
(10) Pub. No.: US 2017/0169159 A1
(43) Pub. Date: Jun. 15, 2017

(54) REPETITION IDENTIFICATION

(71) Applicant: Mercator BioLogic Incorporated, Eagle Mountain, UT (US)

(72) Inventors: Ilia Markovitch Sazonov, Anthem, AZ (US); Roger Ellis Arvisais, Eagle Mountain, UT (US)

(21) Appl. No.: 14/968,223

(22) Filed: Dec. 14, 2015

(51) Int. Cl. G06F 19/18; G06N 3/12; G06F 19/22; G06F 17/30

(52) U.S. Cl. CPC G06F 19/18; G06F 17/3033; G06N 3/126; G06F 19/22

(57) ABSTRACT

A method to identify repetitions may include receiving a pattern of length and maximum insertion length; identifying a plurality of pattern combinations with insertions up to the length, wherein each pattern combination has a head and a tail with an insertion therebetween; creating a head hash of each head and a tail hash of each tail; storing each head hash in association with a corresponding tail hash; searching genetic data for matches to the head hash; identifying a first portion of the genetic data that matches the head hash; identifying a second portion of the genetic data near the first portion of the genetic data that matches the tail hash; storing the head hash and the tail hash; and outputting a pattern combination associated with the head hash and the tail hash.

### FIELD

The embodiments discussed herein are related to the fields of computational biology, genomics, and comparative genetics, and more specifically to the field of string bioinformatics as applied to identifying string repetitions.

### BACKGROUND

The collective genome of the biosphere holds an extraordinary trove of information about the organization and functions of individual cells, organisms, and systems of cells and organisms that has value beyond the sum of its parts. At the nanoscale, individual nucleic acid bases of nucleic acid polymers are relatively indistinguishable, and thus may be difficult to sequence. Moreover, sequence assembly and related tasks are hindered by the use of computing machines controlled by instruction sets with limited throughput, such that chromosomal sequence assembly, and processing may take days, weeks or even months from component sequence fragments. Similarly, analytical tasks such as gene discovery, single nucleotide polymorphism (SNP) identification, indel identification, sequence matching, probe design, homology searches and the like, continue to be hampered by the relative slowness of computers in handling the ACGT base code of a gene (herein referred to as “the genetic alphabet”). In fact, storage alone of the exabytes or yottabytes of information likely to be needed for comprehensive study continues to increase exponentially in databases such as EMBL, GenBank, NCBI, HapMap, and in private repositories, much of the data is essentially inaccessible because of the slowness of the processes needed to search, align, assemble, index and annotate the sequences. Further, with so many individual data points in genetic data, it may be difficult to locate matching strings and/or strings that are similar. Thus, a world of genome biology still remains largely unexplored. These issues of access and analysis have implications not only in medicine, but also for agronomy, animal husbandry, ecology, and biology in general, including systems biology, and there are analogous problems in accessing and manipulating protein sequence databases.

Most conventional sequence matching is done by constructing hash tables to compare the nucleotide sequence (e.g., ACGT sequence) of two identical strings. These conventional methods may include the Needleman-Wunsch string matrix method, and the Smith-Waterman method. Other conventional techniques may be inefficient and may take a significant amount of time (multiple months) to accurately assemble a single human chromosome of the 23 pairs of chromosomes of the human genome. Other techniques may take advantage of known reference sequences (a technique known as “re-sequencing”) to achieve faster sequencing, but must also make compromises on accuracy. Small gaps in the raw data degrade accuracy, and are compensated by increasing redundancy of the reads (typically with coverage of about 40× or more). Re-sequencing to speed the process at low stringency typically may still take more than a week to report a human exome, which is a subset of the human genome. Further, conventional techniques may not be able to locate similar, but not identical, strings.

The power of sequencing in the study of life, its processes, and its place in the natural world is unarguable, but there has been a long-standing unmet need for computational tools, systems and methods that overcome the computational difficulties in sequence assembly and analysis to identify strings that are similar but for one or more insertions and/or deletions. These and other needs are addressed by the data structures, database programming tools, methods, and computing systems of the present disclosure.

### SUMMARY

According to an aspect of an embodiment, a method to identify repetitions may include receiving a pattern of length and maximum insertion length. The method may include identifying a plurality of pattern combinations with insertions up to the length. Each pattern combination has a head and a tail with an insertion therebetween. The method may include creating a head hash of each head and a tail hash of each tail. The method may further include storing each head hash in association with a corresponding tail hash. The method may also include searching genetic data for matches to the head hash. The method may include identifying a first portion of the genetic data that matches the head hash. The method may include identifying a second portion of the genetic data near the first portion of the genetic data that matches the tail hash. The method may further include storing the head hash and the tail hash, and outputting a pattern combination associated with the head hash and the tail hash.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example network architecture in which embodiments of the present disclosure may be implemented;

FIG. 2 illustrates a flow diagram of a method to identify repetitions of molecular patterns of a particular length in genetic code;

FIG. 3 illustrates an example block diagram of a system that may find an approximate string match where the input string being compared may be different than a reference string by one or more additional characters;

FIG. 4 illustrates a method to find an approximate string match where an input string being compared may be different than a reference string by one or more additional characters;

FIG. 5 illustrates a method to search genetic data for a match to a head hash;

FIG. 6A illustrates a method to search genetic data for a match to a tail hash that is close to a head hash that was identified as being a match;

FIG. 6B illustrates a method to search genetic data for a match to a head hash that is close to a tail hash that was identified as being a match;

FIG. 7 illustrates an example block diagram of a system that may find an approximate string match where the input string being compared may be different than a reference string by one or more deleted characters;

FIG. 8 illustrates a method to find an approximate string match where an input string being compared may be different than a reference string by one or more deleted characters;

FIG. 9 illustrates a diagrammatic representation of a machine in the example form of a computing device within which a set of instructions, for causing the machine to perform any one or more of the methods discussed herein, may be executed; and

FIG. 10 is a block diagram of a sequencing machine of the invention that incorporates on-board data processing utilizing the database structures and programming of the invention.

The drawing figures are not necessarily to scale. Certain features or components herein may be shown in somewhat schematic form and some details of conventional elements may not be shown in the interest of clarity, explanation, and conciseness. The drawing figures are hereby made part of the specification, written description and teachings disclosed herein.

### DETAILED DESCRIPTION

Aspects of the present disclosure relate to locating approximate string matches in a genetic code where the string being compared may have been changed by an insertion to or deletion of a portion of the string. Some conventional technologies for matching, sequencing and assembling full chromosomes from string fragments typically rely on string matching algorithms. Nucleic acid sequences may be conventionally represented as a string of characters from the set {A,C,G,T}. Each character may correspond to a nucleobase: Adenine (A), Cytosine (C), Guanine (G), and Thymine (T). Therefore an alphabet set for genetic data is {A,C,G,T}. Software programs for matching strings of alphabetical characters representing the DNA sequences are essentially conventional spell checking programs.

Advances in sequence matching, alignment and assembly are disclosed herein. In an embodiment, a process of “convolution” is applied to reduce the alphabetical symbols to a data structure formed as a matrix of elemental integer values that retains the nucleobase identities, their connections to neighboring nucleobases, and their index position on the string. The data structure may improve string comparisons, reduce resource demands on computer processors, and increase storage density. The matrix may contain the sequence as a matrix of integers and also an embedded natural index order (of the rows) corresponding to the sequence order. Further advancements disclosed in the present disclosure include identification of mutations of all types within any type of data (e.g., genetic material). Techniques described herein may also be used to find near matches in text of all types. For example, a library may store data in a database as ordered strings. Location of a citation may be difficult without knowing the exact wording. By knowing a portion of the beginning and a portion of the end of the string, techniques described herein may find near matches throughout the entire library and allow a user to choose the best citation.

In some embodiments, the some or all of the rows of the data structure may be convoluted into a string and the string may be hashed. The hash may be compared to a reference pattern to find repetitions in the genetic data.

Certain terms are used throughout the following description to refer to particular features, steps or components, and are used as terms of description and not of limitation. As one skilled in the art will appreciate, different persons may refer to the same feature, step or component by different names. Components, steps or features that differ in name but not in structure, function or action are considered equivalent and not distinguishable, and may be substituted herein without departure from the invention. Certain meanings are defined here as intended by the inventors, i.e., they are intrinsic meanings. Other words and phrases used herein take their meaning as consistent with usage as would be apparent to one skilled in the relevant arts. The following definitions supplement those set forth elsewhere in this specification.

“Reference pattern”—a string, hash or sequence maintained in a database and used to help identify repetitions.

“Database” (DB)—as used here, is an organized collection of data contained in a server. The data are typically organized to model relevant aspects of reality in a way that supports processes requiring this information and the role of the server is to maintain and index the data, and to return an answer to a query. For example, databases may be relational, hierarchical or object oriented, and include NoSQL, XML and cloud databases, while not limited thereto. With respect to memory organization, in one embodiment, data is organized into tables defined by a relational variable, generally given as the table name, each table having one or more columns of attributes and each column having one or more rows (“tuples”) that defines a relation, where the relation is a set of one or more elements of a data domain. The term database often refers to both an organized structure of data and a DBMS for indexing, accessing and manipulating that data. In object oriented databases, the data structures may be referred to as “object classes”, the “records” are termed “objects” and the fields, “attributes”, “table”, “row”, “column”, “attribute” and “matrix”.

“Database management systems”—(DBMSs) are software applications that are compiled on database servers to implement data storage, indexing and querying. As used herein, a DBMS is a software system designed to allow the definition, creation, querying, update, and administration of databases. A list of conventional DBMSs includes: MySQL, Oracle RAC, SAP HANA, dBASE, FoxPro, IBM DB2, Adabas, LibreOffice Base, and InterSystems Cache for example.

“Query”—a tool for evaluating, manipulating and extracting data or data subsets in a database, which relies on a query language to combine the roles of definition of data, data transformation, and data query in such standards as SQL. An object model query language is used in OQL. XQuery is an XML query language, and may also be hybridized with SQL in SQL/XML.

“Data structure”—in computer science, a data structure is a particular way of organizing data in a computer so that it can be used efficiently. Different kinds of data structures are suited to different kinds of applications, and some are highly specialized to specific tasks. Most assembly languages and some low-level languages, lack support for data structures. High-level programming and assembly languages, such as Microsoft Macro Assembler (MASM), have special syntax or other built-in support for certain data structures, such as records and arrays. For example, C++ and Pascal support structures and records, respectively, in addition to vectors (one-dimensional arrays) and multi-dimensional arrays. Modern languages usually come with standard libraries that implement the most common data structures. Examples are the C++ Standard Template Library, the Java Collections Framework, and Microsoft's .NET Framework. Modern languages also generally support modular programming, the separation between the interface of a library module and its implementation. Some provide opaque data types that allow clients to hide implementation details. Object-oriented programming languages, such as C++, Java and Smalltalk may use classes for this purpose. Many known data structures have concurrent versions that allow multiple computing threads to access the data structure simultaneously but with very large tables, parts of a large table may have to be broken out for processing or to avoid read conflicts.

A “bot”—refers to a programmable instruction set for data processing that is executed as an autonomous process when provided with appropriate arguments. The bot (or a daemon) may be a process, such as a virtual machine, which iteratively repeats an instruction, a code fragment, or a “script”. Multiple “bots” can operate in a server on a common database in “threads” and may report output back to a common database manager or share the output with other bots.

“Null”—is a reserved keyword used in Structured Query Language (SQL) to indicate that a data value does not exist in the database, such as a sequence position not having a base call. Null serves to enable truth tables that support a representation of “missing information and inapplicable information”. Since Null is not a member of any data domain, it is not considered a “value”, but rather a marker (or placeholder) indicating the absence of a value.

“Hashing”—may refer to a function that can be used to map data of arbitrary size to data of fixed size. The values returned by a hash function are called hash values, hash codes, hash sums, or simply hashes. The hashes may be stored in a hash table.

“Hash table” or “hash map”—is a data structure used to implement an associative array, a structure that can map keys to values. A hash table uses a hash function to compute an index into an array of buckets or slots, from which the desired value can be found.

“Server”—refers to a software engine or a computing machine on which a software engine runs, and provides a service or services to a client software program running on the same computer or on other computers distributed over a network. A client software program typically provides a user interface and performs some or all of the processing of data or files received from the server, but the server typically maintains the data and files and processes the data requests. A “client-server model” divides processing between clients and servers, and refers to an architecture of the system that can be co-localized on a single computing machine or can be distributed throughout a network or a cloud.

A “processor”—refers to a digital device that accepts information in digital form and manipulates it for a specific result based on a sequence of programmed instructions. Processors may be used as parts of digital circuits generally including a clock, random access memory (RAM) and non-volatile memory (ROM, containing programming instructions), and may interface with other digital devices or with analog devices through I/O ports, for example.

“Real Application Cluster”—(RAC) refers to an apparatus and methods for applying multiple processors simultaneously to a single database, thereby increasing computing capacity and performance and improving stability and availability of the overall computing system. The net effects of RAC are commonly referred to as “High Availability” (HA) and “Clustered Performance”. A cluster is defined as a group of independent, but connected servers, cooperating as a single system.

“Node” is a hardware element having at least the following components: a processor—the main processing component of a computer which reads from and writes to the computer's main memory; a memory used for programmatic execution and buffering of data; an interconnect (e.g., a communication link), such as LAN (local area network) or SAN (system area network) between the nodes; and a data storage device accessed by read/write commands. The nodes may incorporate a single microprocessor or multiple microprocessors in symmetrical arrays, also including “constellations.”

“Streaming parallel processing environment”—refers to processing of table structures, where single rows are processed and advanced to a next processor or nodal operation while next rows are input into a first processor or nodal operation, the consecutive processor operations being conducted on clustered arrays of nodes in a non-batchwise and non-blocking manner. Using autonomous bots at each node for threaded data processing, massively streaming parallel processing computations may be performed so as to match, align and assemble nucleic acid polymer sequences and to build and annotate reference libraries used for chromosomal, exomic, epigenetic, and genomic whole sequence bioinformatics.

General connection terms including, but not limited to “connected,” “attached,” “conjoined,” “secured,” and “affixed” are not meant to be limiting, such that structures so “associated” may have more than one way of being associated.

The terms “may,” “can,'” and “might” are used to indicate alternatives and optional features and only should be construed as a limitation if specifically included in the claims. Claims not including a specific limitation should not be construed to include that limitation. The term “a” or “an” as used in the claims does not exclude a plurality.

Unless the context requires otherwise, throughout the specification and claims that follow, the term “comprise” and variations thereof, such as, “comprises” and “comprising” are to be construed in an open, inclusive sense—as in “including, but not limited to.”

A “method”—as disclosed herein refers to one or more steps, operations or actions for achieving the described end. Unless a specific order of steps or actions is required for proper operation of the embodiment, the order and/or use of specific steps and/or actions may be modified without departing from the scope of the present invention.

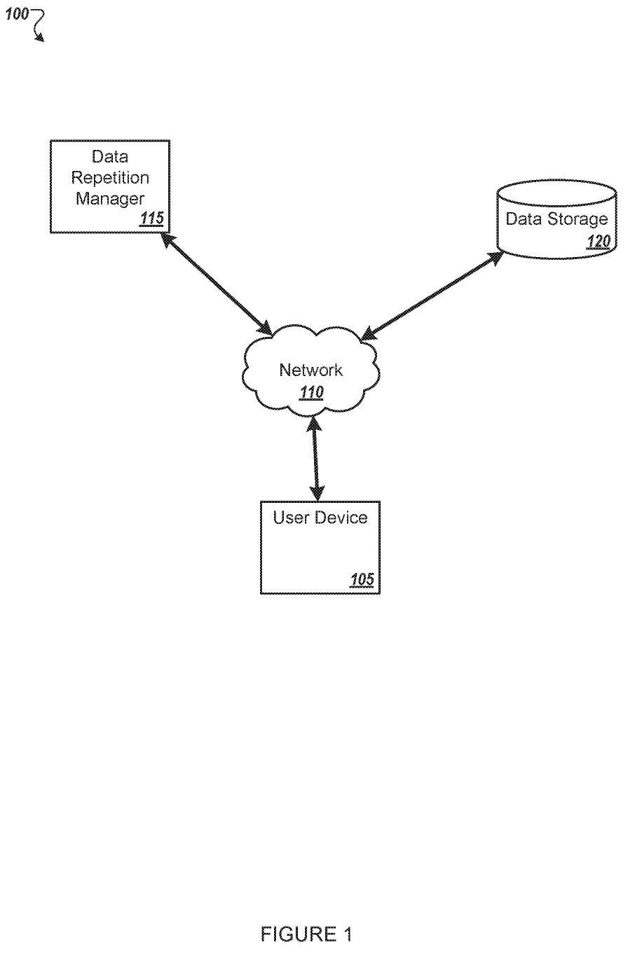

The various methods described herein may be performed by processing logic that may include hardware (circuitry, dedicated logic, etc.), software (such as is run on a general purpose computer system or a dedicated machine), or a combination of both, which processing logic may be included in the data repetition manager 115 of FIG. 1 or another computer system or device. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation. Methods described herein may be executed by multiple threads simultaneously for molecular patterns of different lengths and with different insertion or deletion lengths using multi-threaded processes.

FIG. 1 illustrates an example network architecture 100 in which embodiments of the present disclosure may be implemented. The network architecture 100 includes a user device 105, a network 110, a data repetition manager 115 and a data storage 120.

The user device 105 may include a computing device such as a personal computer (PC), laptop, mobile phone, smart phone, tablet computer, netbook computer, e-reader, personal digital assistant (PDA), or cellular phone etc. Network architecture 100 may support a large number of concurrent sessions with many user devices 105.

The user device 105 may include a user interface (e.g., a graphical user interface (GUI)) that allows a user to input pattern parameters to search for repetitions of data. The pattern parameters may include a pattern of length L, maximum insertion length N and/or a maximum deletion length M. The user interface may also present any found repetitions in the data to the user. In at least one embodiment, the user interface may be a web browser. As a web browser, the user interface may also access, retrieve, present, and/or navigate content (e.g., web pages such as Hyper Text Markup Language (HTML) pages, digital media items, etc.) served by a web server. In another example, the user interface may be a standalone application (e.g., a software program, a mobile application or mobile app).

The network 110 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) or LTE-Advanced network), routers, hubs, switches, server computers, and/or a combination thereof.

The data storage 120 may be a memory (e.g., random access memory), a cache, a drive (e.g., a hard drive), a flash drive, a database system, or another type of component or device capable of storing data. The data storage 120 may also include multiple storage components (e.g., multiple drives or multiple databases) that may also span multiple computing devices (e.g., multiple server computers).

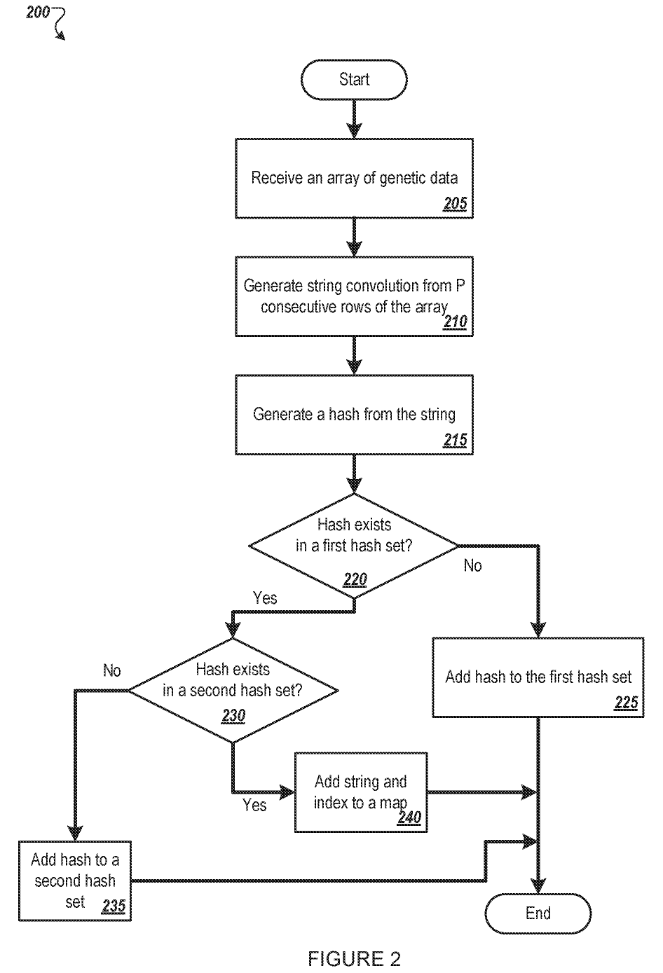

The data repetition manager 115 may include one or more computing devices, such as a rackmount server, a router computer, a server computer, a personal computer, a mainframe computer, a laptop computer, a tablet computer, a desktop computer, etc.), data storages (e.g., hard disks, memories, databases), networks, software components, and/or hardware components. The data repetition manager 115 may identify patterns that are similar to each other and/or to a reference pattern but for one or more insertions and/or deletions, as described herein. Features and operations of the data repetition manager 115 are further described in conjunction with FIGS. 2-8.

Data storage 120 may include any type of data. For purposes of explanation, the data storage 120 may include genetic data. The genetic data may be represented in the data storage 120 as an array or matrix of elements, where each element has at least one of the following attributes: A, C, G, T, and N. In at least one embodiment, the genetic data may be read into the array. A leading 1 may be found in each row. Depending on the location of the leading 1, a symbol may be associated with the row: ‘A’, ‘C’, ‘G’ or ‘T’. Consecutive rows therefore produce a string convolution of that array section. In a relational database management environment, a table is a database structure including rows corresponding to elements and columns designating attributes. In the matrix, each row contains one non-zero number; the column of the non-zero number corresponds to the nucleobase of the original string at that index position. In at least one embodiment, the non-zero number is an integer equaling the index position. Thus the matrix contains an “embedded natural order” as well as the full nucleobase sequence, and may be P×5 rows in length. Input information, such as genetic data, may be stored in an object. The object may include an integer array with genetic data, a character array with molecules' names, and an array with reference patterns if any or an array of required patterns' lengths. The character array may be used to name the patterns. The genetic data may be read into the integer array using buffered technology for better performance.

In some embodiments, data storage 120 is deployed across one or more datacenters. A datacenter is a facility used to house a large number of storage devices. Data in data storage 120 may be replicated across the multiple datacenters in order to provide reliability, availability, and scalability (RAS) features and/or to allow fast load times for the presentation of content on the content hosting website. The manner of replication of data may be selected by a user, may be selected based on one or more replication algorithms, etc.

Although each of the data repetition manager 115 and data storage 120 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

FIG. 2 illustrates a flow diagram of a method 200 to identify repetitions of patterns of a particular length in a set of data. Method 200 may search for patterns of any length, which may be user-defined. The length may be represented as “P.” For the sake of example, FIG. 2 (and other Figures) are described with respect to, but not limited to, finding repetitions of molecular patterns within genetic code.

At block 205, the processing logic may receive a data array of genetic data (e.g., from data storage 120 of FIG. 1). As described herein, the genetic data may be represented as an array (e.g., a matrix) of elements, where each element has the following attributes: A, C, G, T, and N. At block 210, the processing logic may, starting with each row of the array, generate a string convolution from P consecutive rows of the data array. At block 215, the processing logic may generate a string hash from the string that was generated at block 210.

At block 220, the processing logic may attempt to add the string hash created at block 215 to a first hash set. If the string hash created at block 215 does not exist in the first hash set (“NO” at block 220), at block 225 the processing logic may add the string hash to the first hash set. The first hash set may include one entry for each string hash included in the first hash set. Thus, if the hash created at block 215 already exists in the first hash set (“YES” at block 220), at block 230 the processing logic may determine whether the string hash exists in a second hash set. In response to determining that the string hash does not also exist in the second hash set (“NO” at block 230), at block 235 the processing logic may add the string hash to a second hash set. The second hash set may be a set of all repeated hashes. When the string hash already exists in the second hash set (“YES” at block 230), the processing logic may add the string of the string hash and an index at which the string hash is found to a map. If the map does not exist, the processing logic may create the map. In the map, strings may be used as keys (e.g., pattern names) and the entries are the indexes where each molecular pattern is found. The processing logic may repeat the operations of method 200 for any length P to identify repetitions. In at least one embodiment, the processing logic may create and/or use separate data structures for each length P. In at least one embodiment, the processing logic may use the same data structures to store repetition information for each length. The second hash set and/or the map may include information about repetitions in the set of data (e.g., the genetic code). For example, the map may include repetitive strings and their respective location(s) within the set of data.

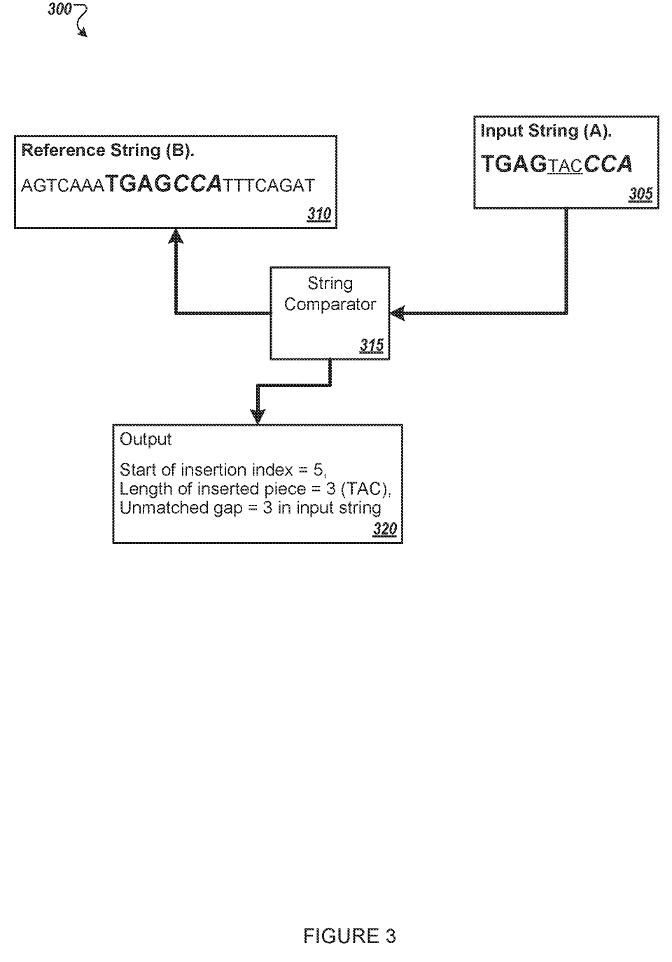

FIG. 3 illustrates an example block diagram of a system 300 that may find an approximate string match where the input string 305 being compared may be different than a reference string 310 (e.g., a reference pattern) by one or more additional characters. As illustrated, the system 300 may receive an input string 305. For example, the input string may be a genetic sequence—TGAGTACCCA. A string comparator 315 may identify a string head (e.g., TGAG) and a string tail (e.g., CCA) of the input string 305. In at least one embodiment, the string comparator 315 is implemented in the data repetition manager 115 of FIG. 1. The input string 305 may have an insertion (e.g., TAC) of any length and at any position in the string between the head and the tail. As illustrated, the input string 305 has an insertion of the characters “TAC.” The string comparator 315 compares the input string 305 to the reference string, while accounting for an insertion. Using the techniques described herein the string comparator 315 identifies the pattern TGAGCCA as being in both the input string 305 and the references string 310, although the input string 305 includes the insertion TAC between the head and tail. The string comparator 315 is able to identify the pattern of TGAGCCA in both the input string 305 and the reference string 310 in spite of the insertion TAC in the input string 305. The string comparator 315 may also find a position of a string head match and string tail match in the reference string 310. The string comparator 315 may store and/or provide an output 320, which may include a start index, a length of the inserted piece, and a length of the unmatched gap. For example, the start of the insertion index may be 5, the length of the inserted piece may be 3 (TAC) and the unmatched gap in the input string may be 3. In at least one embodiment, the length of the inserted piece is different than the unmatched gap.

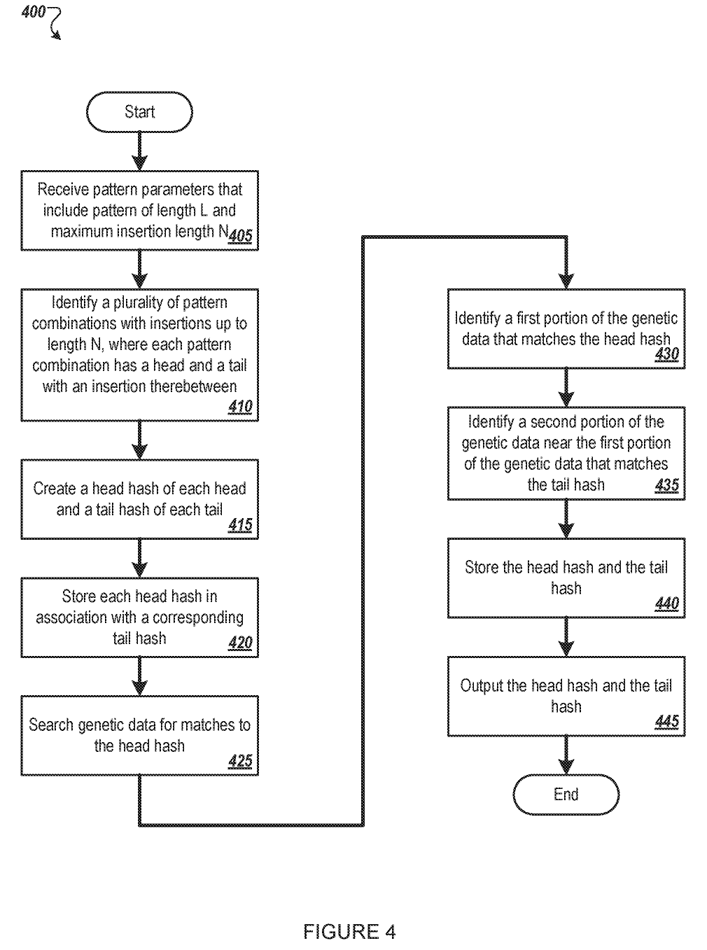

FIG. 4 illustrates a method 400 to find an approximate string match where an input string being compared may be different than a reference string by one or more additional characters. For example, the method 400 may identify repetitions of a molecular pattern while accounting for up to N additional molecules being inserted. The value N may be user-defined.

At block 405, the processing logic may receive molecular pattern parameters that include a pattern of length L and maximum insertion length N. The processing logic may receive the molecular pattern parameters from a user. The molecular pattern parameters may define acceptable search parameters to locate an approximate string match. At block 410, the processing logic may identify a plurality of pattern combinations with insertions up to length N based on the molecular pattern parameters. Each pattern combination may have a head and a tail with an insertion therebetween. For example, a molecular pattern may be of the form [AAAAAA] and N=3. Matches (accounting for insertions) may be identified by splitting the molecular pattern in two parts, e.g. [AA][INSERTION][AAAA], where the insertion is located in between the two parts, in every possible way. The two parts may be referred to as a head (e.g., AA) and a tail (e.g., AAAA). The insertion may be any length up to length N and may include any of the genetic data A, C, G, T, and N. In at least one embodiment, when either the head or the tail is too short, then the partition may be ignored. Thus, when identifying each pattern combination, the processing logic may select partition combination(s) where both the head and the tail are longer or equal to N. The processing logic may store each partition combination in a data storage.

At block 415, the processing logic may create a head hash of each head and a tail hash of each tail. The hash codes of each head hash and each tail hash may be made into a length-2 array and stored in another array at block 420. Therefore, a two-dimensional integer array is created, each row containing two hashes—a head hash and a corresponding tail hash. Moreover, a hash code of the full pattern may be created and added to either of the arrays. In at least one embodiment, the full pattern may be stored as the last row of either of the arrays.

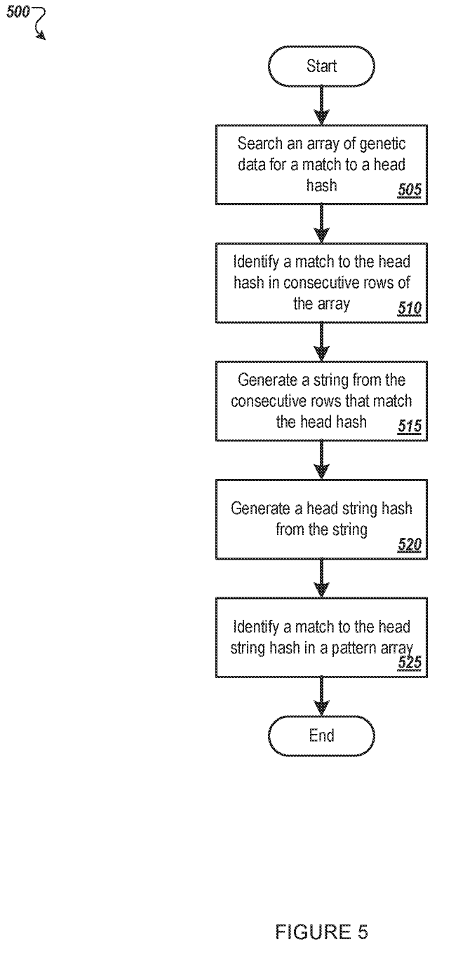

At block 425, the processing logic may search genetic data for matches to the hash of the longest partition (e.g., the head hash or tail hash). The genetic data may be organized in an array or matrix. The processing logic may process the genetic data starting from the first row and move through the rows. Searching the genetic data for matches to the hash of the longest partition created is further described in conjunction with FIG. 5.

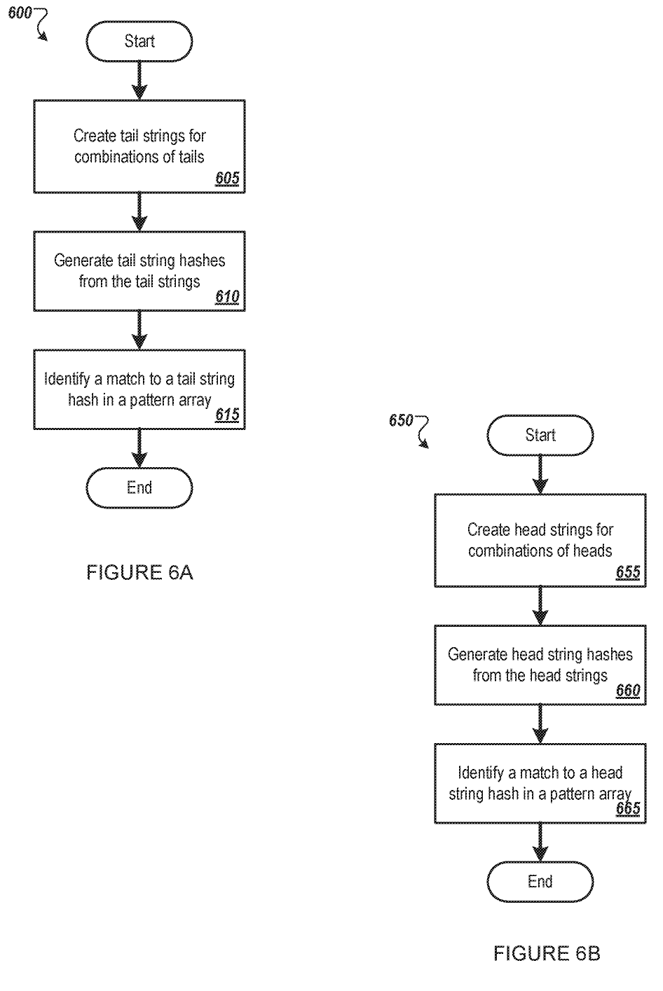

At block 430, the processing logic may identify a first portion of the genetic data that matches the longest partition. In at least one embodiment, the longest partition may match a hashed portion of the genetic data. At block 435, the processing logic may identify a second portion of the genetic data near the first portion of the genetic data that matches the second partition, as further described in conjunction with FIGS. 6A-B. Once a match of both the longest partition hash (at block 425) and a match to the shorter partition hash (either block 430 or 435) is found, the longer partition hash and corresponding shorter partition hash may be determined to be a match. At block 440, the processing logic may store the matched partition hashes in a data storage. In at least one embodiment, the processing logic may store the repetition with an index of the start of the molecular pattern and a length of the insertion in a map, thus, indicating where the match was found and with what insertion.

At block 445, the processing logic may output the matched partition hash values with an indication that the matched partition hashes relate to a repetition in the genetic data. In at least one embodiment, the repetition may be output as a text file.

In general, the larger part of the molecular pattern (e.g., head or tail) is typically found first (either before or after the insertion), and then the smaller part is found in the region around the larger pattern defined by the insertion size. In at least one embodiment, the head hash is larger in length than the tail hash. In at least one embodiment, the tail hash is larger in length than the head hash. In such embodiments, blocks 425 and 430 may be performed for the longer of either the head hash or the tail hash and block 440 may be performed by the shorter of either the head hash or the tail hash. For example, as described above, the head hash is assumed to be larger than the tail hash. Should the tail hash be larger than the head hash, then blocks 425 and 430 may be performed on the tail hash instead of the head hash and block 435 may be performed on the head hash instead of the tail hash.

FIG. 5 illustrates a method 500 to search genetic data for a match to a hash of the longest partition. As described below with respect to FIG. 5, a head hash is longer than the tail hash. In at least one embodiment, the tail hash is longer than the head hash and the description of FIG. 5 may apply to the tail hash as being the longer hash in those embodiments. The head hash may be the head hash as described in conjunction with FIG. 4. Alternatively, when the tail hash is larger than the head hash, the method 500 may search genetic data for a match to the tail hash instead of the head hash.

At block 505, the processing logic may search an array of genetic data for a match to a head hash. The processing logic may cycle through the data array based on values between n-L to n-½*L to search the matches to the greater head hash, where L is the pattern length and where n is the length of the larger partition, in this case the head. At block 510, the processing logic may identify a match to the head hash in consecutive rows of the array. At block 515, the processing logic may generate a string from the consecutive rows that match the head hash. At block 520, the processing logic may generate a head string hash from the string generated at block 515.

At block 525, the processing logic may identify a match to the head string hash in an array of hashed genetic data. When a head string hash matches the genetic data, the processing logic may identify the head that corresponds to the head string hash as being a potential repetition in the genetic data. If the corresponding tail is also determined to be a match, then the head and tail pair may be indicative of a repetition in the genetic data. In at least one embodiment, the two matches with the reference pattern are possible: one where n is the length of the first partition (e.g., the head), or one where n is the length of the last partition (e.g., the tail).

FIG. 6A illustrates a method 600 to search genetic data for a match to a tail hash that is close to a head hash that was identified as being a match in method 500. If n is the length of the first (and larger) partition (e.g., the head), the method 600 may include searching for a smaller partition (e.g., the tail) of size L-n anywhere between 1 and N rows after the end of the larger partition. At block 605, processing logic may create tail strings of size L-n and at block 610, processing logic may generate tail string hashes for each of the tail strings created at block 605. At block 615, processing logic may compare the tail string hashes to a second hash of a reference pattern. If a tail string hash matches the second hash of the reference pattern, then the processing logic has identified a repetition. The tail and the head may be associated with the repetition.

FIG. 6B illustrates a method 650 to search genetic data for a match to a head hash that is close to a tail hash that was identified as being a match in method 500. When the tail hash is larger than the head hash, the method 600 may search genetic data for a match to the head hash instead of the tail hash. If n is the length of the second (and larger) partition (e.g., the head), the method 650 may include searching for a smaller partition (e.g., the head) of size L-n anywhere between 1 and N rows before the start of the larger partition.

At block 655, processing logic may create head strings of size L-n and at block 660, processing logic may generate head string hashes for each of the head strings created at block 655. At block 665, processing logic may compare the head string hashes to a first hash of a reference pattern. If the head string matches the first hash of the reference pattern, then the processing logic has identified a repetition.

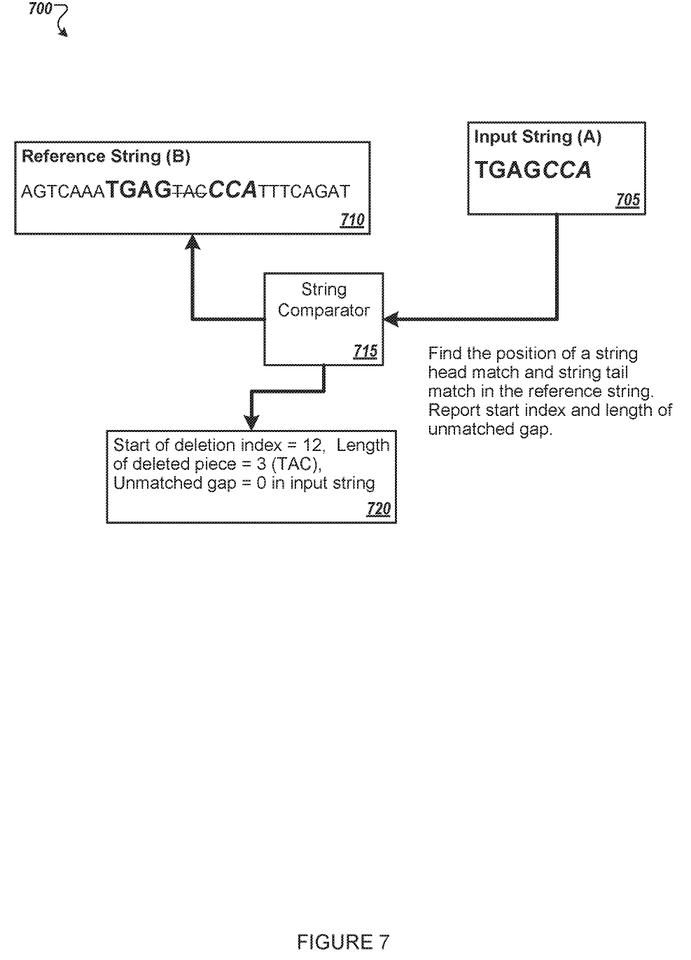

FIG. 7 illustrates an example block diagram of a system 700 that may find an approximate string match where the input string 705 being compared may be different than a reference string 710 by one or more deleted characters. As illustrated, the system 700 may receive an input string 705. For example, the input string may be a genetic sequence—TGAGCCA. A string comparator 715 may identify a string head (e.g., TGAG) and a string tail (e.g., CCA) of the input string 705. The string comparator 715 compares the input string 705 to the reference string 710, while accounting for any deletions in the input string. Using the techniques described herein, the string comparator 715 identifies the pattern TGAGCCA as being in both the input string 705 and the references string 710, although the input string 705 does not include the deletion TAC between the head and tail. The string comparator 715 is able to identify the pattern of TGAGCCA in both the input string 705 and the reference string 710 in spite of the deletion or absence of TAC in the input string 705. The string comparator 715 may also find a position of a string head match and string tail match in the reference string 710. The string comparator 715 may store and/or provide an output 720, which may include a start of deletion index, a length of the delete piece, and a length of the unmatched gap. For example, the start of the deletion index may be 12, the length of the inserted piece may be 3 (TAC) and the unmatched gap in the input string may be 0.

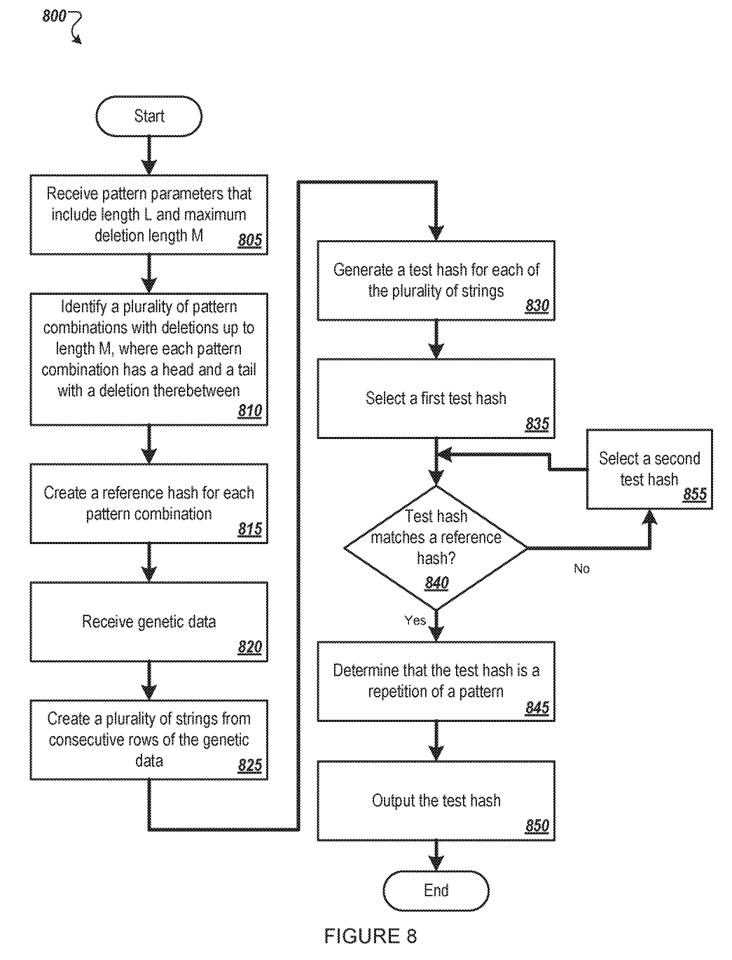

FIG. 8 illustrates a method 800 to find an approximate string match where an input string being compared may be different than a reference string by one or more deleted characters. For example, the method 800 may identify repetitions of a molecular pattern while accounting for up to M additional molecules being deleted. The value M may be user-defined.

At block 805, the processing logic may receive molecular pattern parameters that include a pattern of length L and maximum deletion length M, which may define a reference pattern. The molecular pattern parameters may define acceptable search parameters to locate an approximate string match to the reference pattern. At block 810, the processing logic may identify a plurality of pattern combinations with deletions up to length M, where each pattern combination has a head and a tail with a deletion therebetween. For example, the plurality of pattern combinations may include patterns of length L-M made from the reference pattern. The set may include all possible combinations of patterns with a deleted region. In at least one embodiment, the set may be defined by removing up to M elements from anywhere in the reference pattern, and then remove enough elements from the end to create a pattern of length L-M. This may be sufficient to find all repetitions while accounting for all deletions.

At block 815, the processing logic may create a reference hash for each pattern combination. The processing logic may store each reference hash in a data storage. In at least one embodiment, the reference hashes are stored in a list for faster search.

At block 820, the processing logic may receive genetic data. At block 825, the processing logic may create a plurality of strings from consecutive rows of the genetic data. In at least one embodiment, the genetic data is organized in an array and the processing logic may analyze the array of genetic data row by row. In at least one embodiment, L-M consecutive rows are taken and convoluted into a string of length L-M. The processing logic may store each string in a data storage.

At block 830, the processing logic may generate a test hash for each of the plurality of strings. At block 835, the processing logic may select a first test hash. The processing logic may compare the first test hash against one or more of the reference hashes. If there is a match between the first test hash and a reference hash (“YES” at block 840), then the processing logic may determine that there is a repetition of the pattern at block 845. At block 850, the processing logic may output the test hash and/or an identifier of a repetition. If there is not a match between the first test hash and a reference hash (“NO” at block 840), then at block 855 the processing logic may select a second test hash to use method 800 to determine whether the second test hash is related to a repetition.

In an example illustrating method 800, the processing logic may receive pattern parameters to test whether pattern [ACGTA] is a repetition, L=5. The input parameters may also indicate that and M=2. Another pattern, [AGTA] may exist, where [AGTA] is the same pattern as [ACGTA] with the second element, [C], missing. One of the L-M length patterns created from the original pattern [ACGTA] at block 810 is [AGT], with [C] and [A] removed. When the two patterns are compared at block 840, the first 3 elements of [AGTA] may be considered. Therefore, [AGT] from [AGTA] and the original [AGT] are found equal and a repetition is found at block 845.

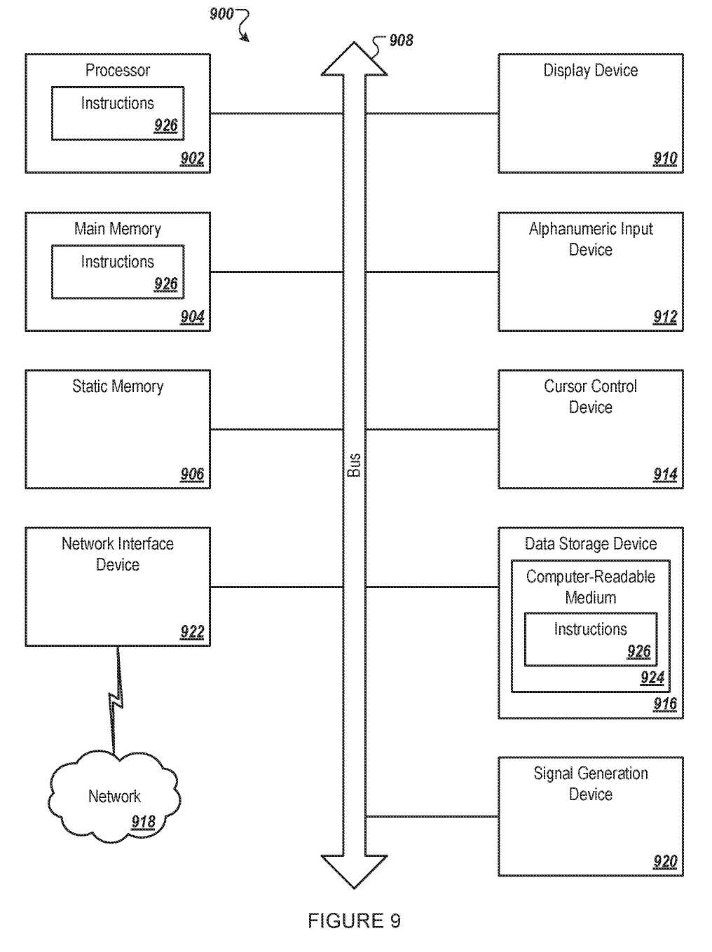

FIG. 9 illustrates a diagrammatic representation of a machine in the example form of a computing device 900 within which a set of instructions, for causing the machine to perform any one or more of the methods discussed herein, may be executed. The computing device 900 may be a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in a client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methods discussed herein.

The example computing device 900 includes a processing device (e.g., a processor) 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 916, which communicate with each other via a bus 908.

Processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computing device 900 may further include a network interface device 922 which may communicate with a network 918. The computing device 900 also may include a display device 910 (e.g., a liquid crystal display (LCD) or a cathode ray tube (CRT)), an alphanumeric input device 912 (e.g., a keyboard), a cursor control device 914 (e.g., a mouse) and a signal generation device 920 (e.g., a speaker). In one implementation, the display device 910, the alphanumeric input device 912, and the cursor control device 914 may be combined into a single component or device (e.g., an LCD touch screen).

The data storage device 916 may include a computer-readable storage medium 924 on which is stored one or more sets of instructions 926 (e.g., channel subscription subsystem, channel content providing subsystem, channel advertisement management subsystem, channel content access management subsystem, composite channel management subsystem) embodying any one or more of the methodologies or functions described herein. The instructions 926 may also reside, completely or at least partially, within the main memory 904 and/or within the processing device 902 during execution thereof by the computing device 900, the main memory 904 and the processing device 902 also constituting computer-readable media. The instructions may further be transmitted or received over a network 918 via the network interface device 922.

While the computer-readable storage medium 924 is shown in an example embodiment to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

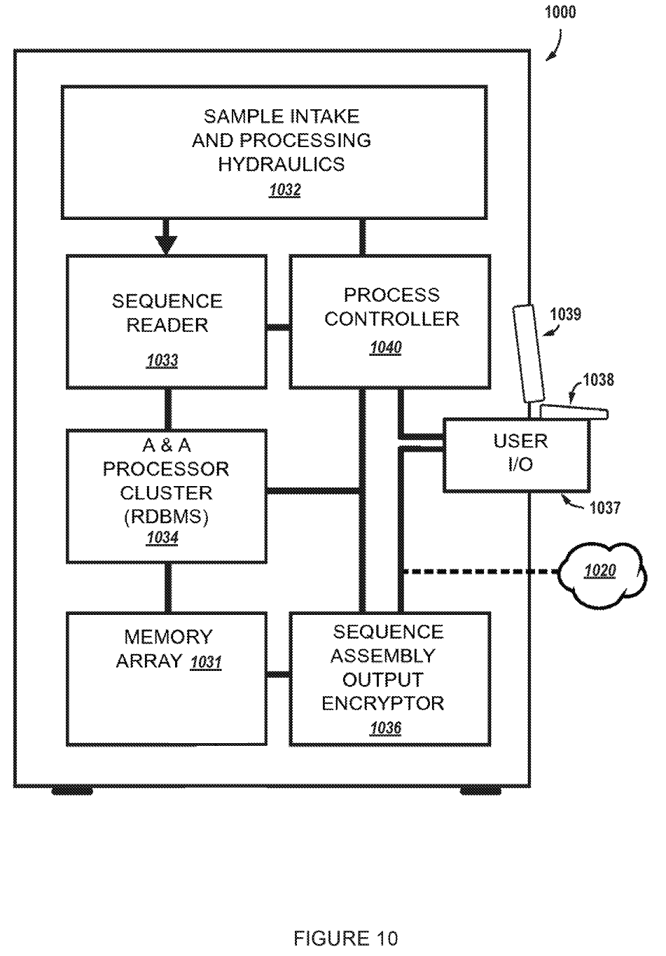

FIG. 10 is a block diagram of a sequencing machine 1000 of the invention that incorporates on-board data processing utilizing string search and repetition location techniques and programming of the present disclosure. Input for assembly is acquired on board through what is generally a wet chemical process that involves sampling, at least endstage sample preparation and labeling, and reading, where reading is a process for determining the order of nucleobases in at least one nucleic acid polymer in the sample. Raw sequence data may be obtained by methods known in the art. Sequence readers using Sanger method based sequencing include those supplied by Illumina, 454 Life Sciences, Visigen, Pacific Biosystems, while not limited thereto. Others such as Oxford Nanopore, Northshore Bio, IonTorrent, Quantum Bio, Mercator BioLogic, and others are developing various optoelectric, direct read sequencing methods. These technologies rely on recent advances in uses of fluorescent base analogues, fluorescence detection, dye-labelled terminators, pyrophosphate enzymology, genetically engineered polymerases, gel electrophoresis, capillary gel electrophoresis, nanopore-based transducers, and microfluidics, while not limited thereto.

In brief, the sequencing machine 1000 is a system having a mechanical, hydraulic and/or pneumo-hydraulic system for manipulation of nucleic acid polymers 1032, a sequence reader system 1033 for detecting and differentiating nucleobases in order of polymerization or depolymerization (or as detected by physical or electrical characteristics of the polymer as it passes through a nanopore), and a processor cluster with RDBMS 1034 for collecting data in digital form, where the option to collect the data as strings of ACGT is supplemented or replaced by database collection and management systems operating on, storing, analyzing and/or outputting data in memory 1031 or transmitting encrypted output (1036), such as via a network connection 1020 shown here schematically as a cloud-based network for example. Systems may also include a user interface 1037 with keypad 1038 and screen 1039. In advanced builds, some functions of the computing cluster may be executed in firmware (not shown).

Machines of this class generally include at least one controller 1040 for synchronizing the process of sample intake, fluid control, power, switching reagents, watchdogging of circuitry, and so forth. The machines may process tens of thousands of bases per second and, in consequence, a processor cluster 1034 is used to align, assemble and annotate the sequence at an equivalent rate to avoid storage of overflow data. In some embodiments, the machines may process read rates exceeding 10 thousand bases per second, per channel on the device, with up to 1200 channels per device which may include reading 12,000,000 bases per second. For re-sequencing, the database manager is configured to manipulate and store data structures that enable rapid comparison of nascent raw sequences with a library of reference sequences, any one of which may occupy 6 GB of memory or more. In an estimate, a reference library of 96 whole genome sequences is appropriate for the human species and advantageous for most re-sequencing, indicating that about 600 GB of data could be indexed and searched during initial matching if gender and ancestry is not assumed. Advantageously, the process is demonstrated to be faster than competing methods of sequencing and alignment and can reduce the on-board computer resources needed for a stand-up sequencing machine of FIG. 10. The above disclosure is sufficient to enable one of ordinary skill in the art to practice the invention, and provides the best mode of practicing the invention presently contemplated by the inventor. While above is a complete description of some embodiments of the present invention, various alternatives, modifications and equivalents are possible. These embodiments, alternatives, modifications and equivalents may be combined to provide further embodiments of the present invention. The inventions, examples, and embodiments described herein are not limited to particularly exemplified materials, methods, and/or structures. Various modifications, alternative constructions, changes and equivalents will readily occur to those skilled in the art and may be employed, as suitable, without departing from the true spirit and scope of the invention. Therefore, the above description and illustrations should not be construed as limiting the scope of the invention, which is defined by the appended claims.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “subscribing,” “providing,” “determining,” “unsubscribing,” “receiving,” “generating,” “changing,” “requesting,” “creating,” “uploading,” “adding,” “presenting,” “removing,” “preventing,” “playing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Further, the terms “first,” “second,” “third,” “fourth,” etc. as used herein are meant as labels to distinguish among different elements and may not necessarily have an ordinal meaning according to their numerical designation.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

Having described the invention with reference to the exemplary embodiments, it is to be understood that it is not intended that any limitations or elements describing the exemplary embodiments set forth herein are to be incorporated into the meanings of the patent claims unless such limitations or elements are explicitly recited in the claims. Likewise, it is to be understood that it is not necessary to meet any or all of the identified advantages or objects of the invention disclosed herein in order to fall within the scope of any claims, since the invention is defined by the claims and inherent and/or unforeseen advantages of the present invention may exist even though they may not be explicitly discussed herein.

While the above is a complete description of selected embodiments of the present invention, it is possible to practice the invention using various alternatives, modifications, combinations and equivalents. Some or all of the processes and/or routines may be performed independently. Any other process or routine described herein may be performed in conjunction with or independent of any other process or routine. Other combinations, order of steps, and improvements are anticipated to realize further advantages while not departing from the spirit of the invention. In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited by the disclosure.

What is claimed is:

1. A method comprising:
receiving a pattern length and maximum insertion length;
identifying a plurality of pattern combinations with insertions up to the pattern length, wherein each pattern combination has a head and a tail with an insertion therebetween;
creating a head hash of each head and a tail hash of each tail;
storing each head hash in association with a corresponding tail hash;
searching genetic data for matches to any head hash;
identifying a first portion of the genetic data that matches a first head hash;
identifying a second portion of the genetic data near the first portion of the genetic data that matches a first tail hash;
storing the first head hash and the first tail hash; and
outputting a pattern combination associated with the first head hash and the first tail hash.

2. The method of claim 1, wherein searching genetic data for matches to any head hash comprises:
searching an array of genetic data for a match to any head hash;
identifying a match to the first head hash in consecutive rows of the array;
generating a string from the consecutive rows that match the first head hash;
generating a head string hash from the string; and
identifying a match to the head string hash in a pattern array.

3. The method of claim 1, wherein identifying a second portion of the genetic data near the first portion of the genetic data that matches the first tail hash comprises:
creating a plurality of tail strings of a size smaller than the head;
generating a tail string hash for each of the tail strings;
comparing the tail string hashes to a second hash of a reference pattern; and
in response to a tail string hash matching the second hash of the reference pattern, determining that the head and the tail are associated with a repetition.

4. The method of claim 1 further comprising determining that the first head hash and the first tail hash are associated with a repetition in the genetic data.

5. The method of claim 1, wherein the reference pattern is associated with an exome, a chromosome, or a genome.

6. The method of claim 1 further comprising receiving a minimum insertion length that is greater than two characters.

7. The method of claim 1, wherein the head has a larger length than the tail.

8. The method of claim 1, wherein the pattern length indicates the length of an identified repetition, and wherein the maximum insertion length indicates a threshold number of elements by which a repetition and a reference pattern may differ.

9. The method of claim 8, wherein each of the plurality of pattern combinations are each a discrete reference pattern.

10. A system comprising:
a memory; and
a processor operatively coupled to the memory, the processor configured to perform operations comprising:
receive a pattern of length L and maximum deletion length M;
identify a plurality of pattern combinations with deletions up to length M, where each pattern combination has a head and a tail with a deletion therebetween;
create a base hash for each pattern combination;
receive a set of data;
create a plurality of strings from consecutive rows of the set of data;
generate a test hash for each of the plurality of strings;
select a first test hash;
determine whether the test hash matches a base hash;
in response to a determination that the test hash matches a base hash, determine that the test hash is associated with a pattern combination that is a repetition;
in response to a determination that the test hash does not match a base hash, selecting a second test hash to determine whether the second test hash is associated with a pattern combination that is a repetition; and
output a pattern combination that is associated with the test hash.

11. The system of claim 10, wherein the set of data is genetic data that relates to an exome, a chromosome, or a genome.

12. The system of claim 10, wherein the test hash is output in a list that includes repetitions that account for insertions and deletions.

13. A non-transitory computer readable storage medium comprising instructions that, when executed by a processor, cause the processor to perform operations comprising:
receive a pattern of length and maximum insertion length;
identify a plurality of pattern combinations with insertions up to the length, wherein each pattern combination has a head and a tail with an insertion therebetween;
create a head hash of each head and a tail hash of each tail;
store each head hash in association with a corresponding tail hash;
search a set of data for matches to the tail hash;
identify a first portion of the set of data that matches the tail hash;
identify a second portion of the set of data near the first portion of the set of data that matches the head hash;
store the head hash and the tail hash; and
output the head hash and the tail hash.

14. The non-transitory computer readable storage medium of claim 13, wherein searching the set of data for matches to the tail hash comprises:
search an array of genetic data for a match to a tail hash;
identify a match to the tail hash in consecutive rows of the array;
generate a string from the consecutive rows that match the tail hash;
generate a tail string hash from the string; and
identify a match to the tail string hash in a pattern array.

15. The non-transitory computer readable storage medium of claim 13, wherein identifying a second portion of the set of data near the first portion of the set of data that matches the head hash comprises:
creating a plurality of head strings of a size smaller than the tail;
generating a head string hash for each of the head strings;
comparing the head string hashes to a third hash of a reference pattern; and
in response to a head string hash matching the third hash of the reference pattern, determining that the head and the tail are associated with a repetition.

16. The non-transitory computer readable storage medium of claim 15, wherein the reference pattern is associated with an exome, a chromosome, or a genome.

17. The non-transitory computer readable storage medium of claim 13 further comprising receiving a minimum insertion length that is greater than two characters.

18. The non-transitory computer readable storage medium of claim 13, wherein the head has a larger length than the tail.

19. The non-transitory computer readable storage medium of claim 13, the processor being further configured to determine that the head hash and the tail hash are associated with a repetition in the set of data.

20. The non-transitory computer readable storage medium of claim 13, wherein the pattern length indicates the length of an identified repetition, and wherein the maximum insertion length indicates a threshold number of elements by which a repetition and a reference pattern may differ.
